(19) United States
(12) Patent Application Publication
(10) Pub. No.: US 2012/0174796 A1
(43) Pub. Date: Jul. 12, 2012

(54) METHOD AND DEVICE FOR PRODUCING A MIXED PRODUCT, IN PARTICULAR A MIXED BEVERAGE

(75) Inventor: Klaus Ehrlinger, Frondenberg (DE)

(73) Assignee: KHS GmbH, Dortmund (DE)

(21) Appl. No.: 13/496,908

(22) PCT Filed: Sep. 7, 2010
(86) PCT No.: PCT/EP10/05477

§ 371 Date: Mar. 19, 2012

(30) Foreign Application Priority Data
Nov. 24, 2009 (DE) 10 2009 054 313.9

(51) Int. Cl. G05D 11/02; B01F 3/04; A23L 2/54; B01F 15/04

(52) U.S. Cl. 99/323.2; 366/153.1; 366/152.2

(57) ABSTRACT

The invention relates to a method for producing a liquid mixed product from at least one liquid base component and at least one liquid additive, which is added to the base component in a metered manner, wherein the at least one liquid additive is metered into the base component depending on the amount of the mixed product removed from the mixing chamber (2.3).

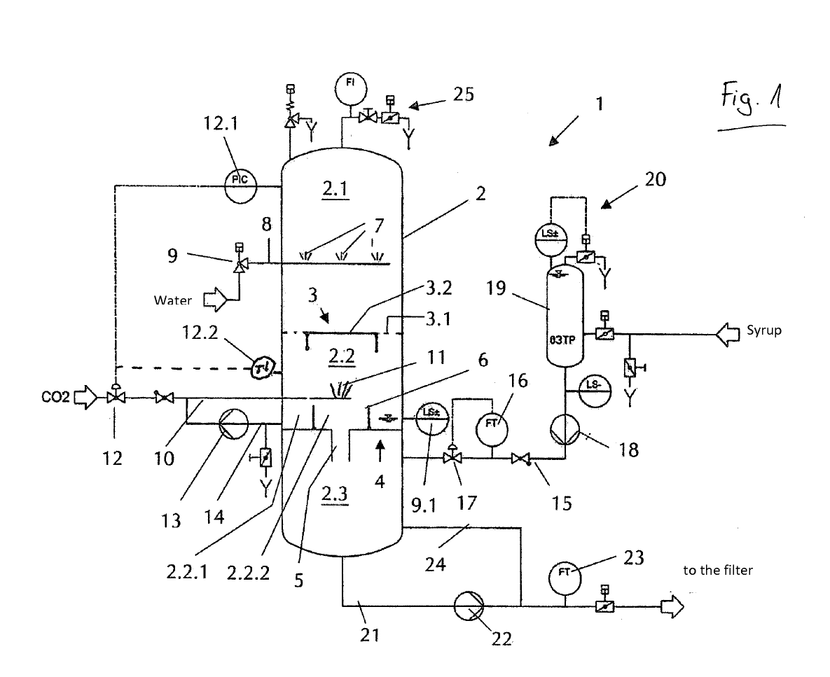

The invention relates to a method according to patent claim 1 as well as to a device according to patent claim 5 or 7, each for producing mixed products which, for example as mixed beverages, consist of at least one liquid basic or base component and from at least one additive which is added to the base component in a metered manner, the latter of which is a liquid additive and/or a gaseous additive in the form of a CO₂ gas.

Methods as well as devices for producing mixed products in the form of mixed beverages and, in particular, of carbonated mixed beverages or mixed beverages containing carbonic acid, are known.

Generally, when producing mixed beverages, it is necessary to first degas the liquid basic or base component which, for example, is formed by beverage water, and then to mix with at least one preferably flavouring additive (for example syrup) to the required end concentration. If the mixed beverage is a carbonated beverage, a carbonation and a buffering of the mixed beverage with CO₂ gas will be performed until the filling into containers or bottles. Such mixed products are processed in mixing systems (often called mixers) consisting of several components.

The degassing of the at least one base component can be performed in different ways, for example through single- or multi-stage vacuum degassing and/or through single- or multistage pressure degassing. During vacuum degassing, the partial pressure drop which is necessary for the release of foreign gases dissolved in the at least one base component is achieved by vacuum or pressure drop. During pressure degassing, the release of the foreign gases from the particular base component is achieved by diffusion in a carrier gas free from oxygen and/or nitrogen, e.g. CO₂ gas.

The mixing of the base component with the at least one additive (for example syrup) into the finished or mixed product is currently performed via a ratio control, i.e. by controlling the volume flows of the base component and of the additive to a respective setpoint. Both setpoints are put into a ratio according to the preselected or desired formulation. To achieve the required dosing accuracies, continuous control of the volume flows, in particular continuous volume flows through the particular mixing chamber, will be required.

The carbonation or dosing of the CO₂ gas, for known methods and mixing systems, will also be performed via ratio dosing or via spray carbonation. In the latter case, the mixed product is sprayed into a container pressurised with CO₂ gas. The gas pressure is set according to the saturation pressure which, inter alia, depends on the dosing rate and the temperature. The CO₂ gas dissolves in the mixed product until a balance is achieved between the pressure of the CO₂ gas atmosphere and the CO₂ gas partial pressure or saturation pressure of the carbonated mixed beverage.

The carbonated mixed product or mixed beverage produced with the mixing system is usually filled, by means of a filler, into container or bottles. Like the mixing system, the latter is a component part of one complete filling line. Through disruptions in the environment and/or in the system and/or through disruptions of the packaging material (for example bottle breakage etc.), stops or reduced output will often occur. However, since continuous operation is required for the dosing accuracy of mixing and carbonation, known systems require, for uncoupling or buffering between mixing system and filler, a buffer or buffer tank which, for known mixing systems, must have a relatively large volume, for example a volume of up to 1000 litres. Usually, such buffer tanks are operated with a heavily fluctuating fill level, so that the mixed product in the buffer tank must be overlaid with a CO₂ gas cushion whose pressure is higher than the CO₂ saturation pressure in the mixed product. In case of changing fill levels, it will be necessary to replenish the buffer tank concerned with CO₂ gas or to drain it, which leads to a high consumption of CO₂ gas.

A device and a method for producing mixed products were introduced by DE 1 213 212. Consequently, this publication provides for the base component, for example water, and the additive, for example syrup, to be simultaneously fed to a dosing unit, wherein the components enter a mixing vessel at a preset, accurately measured quantity ratio. The disadvantage of this procedure is that known dosing units for the simultaneous feeding of several components are complex and expensive and, moreover, usually only have limited accuracy.

The task of the invention is to show a method for producing mixed products from at least one base component and from at least one additive which, while maintaining a high dosing accuracy, can be performed with less complex controls and/or fewer machinery requirements. To solve this task, a method has been developed according to patent claim 1. A device for producing mixed products by mixing at least one base component with one additive is the subject matter of patent claim 5 or 7.

The at least one basic or base component is a liquid component. The at least one additive is a liquid and/or a gaseous component and, in the latter case, CO₂ gas.

The metered addition of the at least one preferably liquid additive to the at least one liquid base component in the mixing chamber is achieved in the manner that the adding or dosing of the at least one additive is controlled or regulated depending on the quantity of the mixed product which (the quantity) is removed from the mixing chamber. This, preferably, then provides means for a level- or volume-controlled feeding or refilling of the at least one base component into the mixing chamber such that, by feeding or refilling of the at least one base component, the total volume formed in the mixing chamber by the at least one base component and the at least one additive is constant.

The metered addition of the at least one additive in the mixing chamber can be performed continuously, or intermittently or batch-wise. Preferably, the mixing chamber simultaneously forms the buffer from which the mixed product is fed to the filler which follows the overall systems. As the mixing does not require continuous operation, the mixing chamber and, thus, also the buffer or buffer tank formed by this mixing chamber can be implemented with a reduced volume, for example with a volume of only 100 litres at a nominal capacity of the device or mixing system of 30 m³/h. Through the reduced volume of the mixing chamber alone, which also serves as a buffer tank, there is a substantial reduction in the size of the mixing system or device for producing mixed products according to the invention.

According to a further aspect underlying the invention, at least two functions of conventional mixing systems are combined in a common functional container, for example the functions of degassing and subsequent carbonation of the at least one base component. The functional container or a functional space created within it then serves, preferably, also as a mixing chamber and preferably as a combined mixing chamber and buffer tank.

The level- or volume-controlled feeding of the at least one base component into the mixing chamber, in the simplest case, is achieved by the mixing chamber having, on at least one mixing chamber inlet for the at least one base component, a level-determining element, for example in the form of an overflow, and by means being provided for constantly overflowing the mixing chamber inlet during the operation of the mixing system or device with the at least one base component.

Further developments, advantages and possible applications of the invention also follow from the description below of typical examples and from the figures. Basically, all features described and/or depicted, for themselves or in any combination, are the subject matter of the invention, irrespective of their summary in the claims or their retrospectivity. The content of the claims is also made a part of the description.

Hereinafter, the invention is clarified using the FIGURE which, in a schematic functional representation, shows a mixing system according to the invention.

The mixing system or device, which is generally designated with 1 in the FIGURE, serves to produce a carbonated liquid mixed product, i.e. with carbonic acid or CO₂ gas added, preferably a mixed beverage, by mixing one liquid main or base component, for example water, with at least one liquid additive, for example with a flavouring additive, e.g. syrup.

For the device 1, all functions and components usually featured in a mixing system are combined in the single functional container 2, namely the degassing or liberation of the base component (e.g. water) from unwanted foreign gas components dissolved in this base component, the metered addition of CO₂ gas to the base component, for example with a quantity corresponding to the CO₂ saturation pressure of the mixed product, the metered feeding of the at least one additive as well as the function of the buffer.

For this, the internal space of the functional container 2 is divided into three functional spaces 2.1-2.3 by two horizontal or essentially horizontal partitions 3 and 4 which, in the direction of the vertical axis of the functional container 2, connect to each other and of which, in the manner clarified below, the uppermost functional space 2.1 essentially serves for pressure degassing and for the at least partial carbonation of the base component (for example water), the bottom-most functional space 2.3 essentially serves as mixing chamber for the mixing of the base component with the at least one additive as well as simultaneously as a buffer and the functional space 2.2 arranged between the functional spaces 2.1 and 2.3 serves, inter alia, for the complete carbonation of the base component to the CO₂ deconcentration as well as the controlled feeding of the base component to the functional space 2.3.

In the embodiment shown, the partition 4 is provided with a central passage 5 which connects the separate areas 2.2 and 2.3 and, for the embodiment shown, is implemented as an immersion tube reaching into the separate area 2.3. In the area of the functional space 2.2, the passage 5 is enclosed by an ring-shaped overflow barrier 6 so that, on the underside of the functional space 2.2, i.e. at the partition 4, two separate areas are formed, that is an outer ring-shaped separate area 2.2.1 between the inner surface of the wall of the functional container 2 and the overflow barrier 6 and an inner separate area 2.2.2 which, via the passage 5, is connected with the functional space 2.3.

In the functional space 2.1, at a distance from both the partition 3 limiting this functional space at the bottom and at a distance from the top of the functional container 2, several nozzles 7 are arranged which, via a line 8 with control valve 9, are connected to a source (not shown) for the provision of the liquid base component. The nozzles 7 are arranged and designed such that, for the opened control valve 9, the base component is finely sprayed out of the nozzles 7 in a vertical direction upward and then falls back onto the partition 3 which is, for the embodiment shown, in the boundary area 3.1, i.e. near the wall of the functional container 2, designed as a perforated plate or perforated floor with a plurality of openings and, in its central area 3.2, as a closed wall or as a closed floor.

Into the functional space 2.2 goes a line 10 which, on the inside of the functional space 2.2, is provided with at least one nozzle 11 which is located at a distance above the overflow barrier 6 and above the separate area 2.2.2 as well as at a distance below the section 3.2 of the partition 3 designed as a baffle. The nozzle 11 is designed and arranged such that the nozzle jet exits from this nozzle in a vertical upward direction, i.e. aimed at section 3.2 which serves as a rebound wall. The line 10 is connected, via a control valve 12, with a source (not shown) which provides the CO₂ gas under pressure. The control valve 12 is controlled such that the gas pressure within the functional container 2 and, in particular, within the functional spaces 2.1 and 2.2, corresponds with the CO₂ concentration in the produced mixed product, also taking into account, inter alia, further parameters such as the temperature of the mixed product, dosing or formulation of the mixed product etc. Preferably, the control valve 12, for example taking into account measuring signals which supply the pressure sensors 12.1 and/or temperature sensors 12.2 provided at the functional spaces 2.1 and 2.2, is controlled such that the CO₂ pressure in the functional container 2 is adjusted so high that the desired CO₂ content in the mixed product is achieved, taking into account that adding the CO₂-free syrup results in a reduction of the CO₂ content in the finished product.

To the line 10, in the flow direction of the CO₂ gas, following the control valve 12, the exit or the pressure side of a pump 13 is connected, which, with its input, is linked with the separate area 2.2.1 via a line 14.

For the metered addition of the additive, the functional space 2.3 which serves as a mixing chamber and simultaneously as a buffer, is connected to a line 15 which, inter alia, provides a dosing valve 17 controlled by a suitable meter such as a flowmeter 16 and a pump for feeding the additive under pressure. The flowmeter 16, for example, is a magnetically inductive flowmeter (MID). To simplify the dosing or the control of the dosing valve 17, it is preferred that a density measurement be integrated into the flowmeter 16, thus enabling a dosing which, inter alia, is independent of temperature and/or pressure or at least largely independent of temperature and/or pressure.

However, the meter may also be a mass flowmeter (MDM) through which, on the one hand, the volume flow cannot be measured directly but, through which, the mass flow, the density and also the temperature can be ascertained.

The input of the pump 18 is connected via a bleed container 19 (bleed lantern) with a source (not shown) for the provision of the additive. At the beginning of each production phase, the bleed container 19 is bled via a bleed valve arrangement 20 so that this container is then completely filled with the additive and thus, in particular, does not require a buffering of the additive in the bleed container 19 by a pressurised inert gas buffer, for example CO₂ gas buffer, contributing substantially to the reduction of the inert gas or CO₂ gas consumption.

On the floor of the functional space 2.3, in which at least one mixing element (not shown) is provided, a product line 21 with pump 22 and flowmeter 23 is connected via which (product line) the device 1 is connected with a filling machine (not shown) for the filling of bottles or other containers with the mixed product. Between the output of the pump 22 and the flowmeter 23, a return line 24 is connected to the product line 21 so that, independent of each current quantity of the mixed product delivered to the filling machine and registered by the flowmeter 23, the pump 22 can, for example, be operated with constant output. The flowmeter 23, for example, is a magnetically inductive flowmeter (MID) and, of course, designed such that it registers phases with stop/go operation and/or with a reduced output of the filler, without error.

The operating principle of the device 1 can be described as follows:

In the functional space 2.1, as already explained, occurs the degassing as well as simultaneously the at least partial carbonation of the base component with, for example, 80-90% of the CO₂ deconcentration of the mixed product. For this, just like the rest of the internal space of the functional container 2, the functional space 2.1 is also pressurised with the required CO₂ gas pressure, controlled by the control valve 12.

Via the nozzles 7, the base component is sprayed upward in the direction of the ceiling or in the direction of the upper limit of the functional space 2 and then rains back onto the floor of the functional space 2.1 formed by the partition 3. This is where a pressure degassing of the base component occurs by diffusion as well as simultaneously by the carbonation of the base component. It is in balance with the CO₂ gas pressure in the functional space 2.1 (CO₂ pressure equals saturation pressure). By spraying the base component from the nozzles 7 upward and by the raining back of the sprayed base component from top to bottom, the height of the functional space is doubly used, which leads to an extension of the dwelling time of the sprayed base component in the functional space 2.1 and also to an enlargement of the exchange surface between the base component and the CO₂ gas in the functional space 2.1. The foreign gas proportion in the base component after treatment is down to about 10% or less.

The degassed and carbonated base component backs up on the partition 3 and then passes through the openings [sic] partition section 3.1 into the functional space 2.2, that is into its separate area 2.2.1 arranged below the partition section 3.1. In this separate area 2.2.1, at least one fill level sensor 9.1 controlling the control valve is provided which, for example, is formed by a min/max probe and controls the liquid level in the separate area 2.2.1 such that the level of this liquid level [sic] constantly is well below the upper edge of the overflow barrier 6.

With the pump 13 which, preferably, runs with constant output V13 during the operation of the device 1, the base component is constantly delivered from the separate area 2.2.1 via the line 10 to the nozzle 11 arranged over the separate area 2.2, i.e. the separate area 2.2.2 and thus the inlet to the functional space 2.3 are constantly overflown with the base component. Simultaneously, the base component in the line 10 is mixed with the CO₂ gas delivered via the control valve 12, in a manner that the base component discharged from the at least one nozzle 11 upward into the functional space 2.2 and against the partition section 3.2 serving as a rebound wall has a [sic] CO₂ proportions well above the CO₂ saturation, for example a CO₂ concentration of 210% of the CO₂ saturation concentration. After the exit of the base component from the at least one nozzle 11, excess CO₂ gas is released within the functional space 2.2. This CO₂ gas of the functional space 2.2, which is released or liberated through “flashing”, counter-flows through the partition section 3.1 formed as a perforated floor into the functional space 2.1. Thus, the CO₂ gas flow which is free from foreign gases, sparges the base component which goes through the partition section 3.1 and flows, in free downward fall, into the separate area 2.2.1, something which, inter alia, leads to a complete carbonation of the base component so that it then has the desired CO₂ deconcentration, for example in the form of a 100% CO₂ saturation. Furthermore, the CO₂ gas released in the functional space 2.2 through “flashing” and flowing through the partition section 3.1 of course also serves to pressurise the separate area 2.1 with the required CO₂ gas pressure.

For this, the greater part of the CO₂ gas which has entered the functional space 2.1 via the partition section 3.1, is used in the manner described above for the degassing and simultaneous carbonation of the base components discharged from the nozzles 7. A smaller proportion, for example 10% of this CO₂ gas, is drained via valve arrangement provided at the top of the functional container 2 or of the functional space 2.1 (which, in practice, is also called foreign gas sniffing 25), for discharging the spoil gases removed from the base component.

During the entire operation of the device 1, the functional space 2.3 is always completely filled with the mixed product, such that the liquid queues from the separate area 2.3 through the passage 5 into the separate area 2.2.2 up to the upper edge of the overflow barrier 6. The additive, controlled via the dosing valve 17, is delivered continuously, or intermittently or batch-wise, through the flowmeter 16, depending on the quantity of the mixed product removed from functional space 2.3 and delivered to the filler via the product line 21, i.e. depending on the measuring signal of the flowmeter 23 and depending on the required dosing of the additive in the mixed product.

If the formulation stays unchanged, the additive is thus dosed ultimately depending on the quantity of mixed product removed from the device 1 via the product line 21.

For this, the functional space 2.3 which serves as a mixing chamber and buffer, is constantly filled with the base component, this being achieved by at least the greater part of the base component, which exits from the at least one nozzle 11, reaching the top of the separate area 2.2.2.

If the liquid level in the separate area 2.2.2 has sunk to below the level of the upper edge of the overflow barrier 6 and thus requires refilling of the separate area 2.3 with the base component, the base component which entered the separate area 2.2.2 enters via the passage 5 into the separate area 2.3.

If, however, the separate area 2.2.2 is completely filled with base component, the base component discharged from the nozzle 11 flows back via the edge of the overflow barrier 6 into the separate area 2.1.1. A direct mixing of the base component accommodated in the separate area 2.2.1 with the component in the separate area 2.2.2 or with the mixed product in the separate area 2.3 is avoided through the partition 4 with the overflow barrier 6.

In the normal operational state, however, a part of the base component entering into the separate area 2.2.2 will enter through the passage 5 into the separate area 2.3, whereby the other part of the one [sic] from the separate area 2.2.2 will flow over into the separate area 2.2.1.

To enable this dosing of the additive alone through the control of the additive depending on the removed quantity of the finished mixed product, the pump 13 has an output V13 which is greater than the output V22 of the pump 22. Independent of the particular operational state of the pump 22, the output V13 of the pump 13 in any case is greater than the maximum output V22 of the pump 22. This ensures the continuous overflowing of the separate area 2.2.2 or of the overflow barrier 6 and also ensures that the separate area 2.3 always has a constant fill level and the base component removed with the finished mix via the product line 21 is always replaced immediately.

Advantages of the device 1 according to the invention include its compact construction, the particularly straightforward control of the dosing of the at least one additive as well as, in particular, a reduced consumption of CO₂ gas. The entire mixing system, for example, is combined in a single functional container. The functional space 2.3 forms both the mixing container and the buffer.

Through the type of control or regulation of the dosing according to the invention, a continuous volume flow is not required within the device 1 for the proper function of the mixing system—in contrast to the state of the art—so that, in contrast to known mixing systems, a high-volume buffer tank is not required for ensuring the continuous operation of the mixing system even for a stop/go operation of the filling machine.

For a nominal capacity of the device 1 of 30 m³/h, a volume of only 100 I is completely sufficient for the functional space 2.3 which also serves as a buffer, which contributes to a substantial reduction in the construction volume of the device 1, in particular taking into account the fact that known systems require buffers with much greater volume.

A further advantage of the invention also is that, through the described design and control of the device 1, the functional space 2.3 which serves as the mixing container and buffer is constantly filled to the brim thus avoiding an overlay of the mixed product in the functional space 2.3 with a CO₂ cushion and the resulting CO₂ losses and any unwanted re-carbonation. Furthermore, there is the possibility of re-dosing the mixed product accommodated in the functional space 2.3 through the additional introduction of at least one additive into this functional space, for example to compensate for faulty dosages such as those caused by a faulty concentration of the additive etc.

The invention was described above using a typical example. It is understood that numerous changes as well as modifications are possible without departing from the idea on which the invention is based.

For example, it is possible to integrate a quality measurement (Brix or CO₂ measurement) into the return line 24. It is further possible to perform the degassing and carbonation of the base component in more than one stage, for example also in the form that, in the common functional container 2, several functional spaces corresponding with the functional space 2.1 are provided, that is, as regards their function, successively in a cascaded manner such that the base component degassed and at least partially carbonated in a first functional space is again degassed and re-carbonated in a further functional space etc. Furthermore, of course, it also possible to perform at least the degassing and, if required, also the degassing and pre-carbonation of the base component in an additional system.

Above, it was assumed that the degassing of the base component is performed by single- or multi-stage pressure degassing. Of course, for the device or mixing system according to the invention, vacuum degassing is also possible.

Above, it was further assumed that the base component only has one additive added. Of course, the mixing system or device according to the invention can also be designed for adding two or more than two, even different, additives to at least one base component, wherein, however, all versions preferably have in common that the dosing of the at least one liquid additive to the at least one base component is performed depending on the removed quantity of the mixed product. For this, in particular, there is the possibility of connecting the functional space 2.3 via the particular independent dosing valves with different sources for different additives or to provide a common dosing valve for several different additives, wherein the dosing valves, preferably, again are controlled depending on the quantity of the product removed from the device.

It is a vital advantage of the method according to the invention that the mixed product does not have to be intermediately stored, after its production, in a buffer tank since the application of the science according to the invention now makes it possible to continuously produce the mixed product even in varying quantities per time unit.

Another vital advantage of the method according to the invention is that now it is no longer necessary to apply a CO₂ gas cushion to the mixed product, after its production, whose pressure is higher than the CO₂ saturation pressure in the mixed product. This is due to the now-possible continuous production of the mixed product even in varying quantities per time unit, which does not require buffering in a buffer tank. Through this procedure according to the invention, the consumption of CO₂ gas is substantially reduced.

### REFERENCE SYMBOL LIST

1 mixing system or device
2 functional container
2.1-23 functional space
2.2.1, 2.2.2 separate area
3,4 partition
3.1, 3.2 partition section
5 passage
6 overflow barrier
7 nozzle
8 line
9 control valve
9.1 fill level sensor
10 line
11 nozzle
12 control valve
12.1 pressure sensor
12.2 temperature sensor
13 pump
14 line
15 line
16 flowmeter
17 dosing valve
18 pump
19 bleed container or lantern
20 bleed facility
21 product line
22 pump
23 flowmeter
24 return line
25 foreign gas sniffing

1-13. (canceled)

14. A method for producing a liquid mixed product from at least one liquid base component and at least one additive that is added to said liquid base component in a metered manner, said method comprising adding said at least one additive to said at least one liquid base component to an extent that depends on a quantity of said liquid mixed product removed from a mixing chamber.

15. The method of claim 14, further comprising delivering said at least one liquid base component to said mixing chamber in at least one of a volume controlled manner and a level controlled manner such that a volume occupied by said at least one liquid base component and said at least one additive in said mixing chamber remains constant.

16. The method of claim 14, further comprising delivering said at least one liquid base component to said mixing chamber in at least one of a volume controlled manner and a level controlled manner such that a quantity of said at least one liquid base component refilled into said mixing chamber equals a proportion of said at least one liquid base component removed from said mixing chamber.

17. The method of claim 16, wherein delivering said at least one liquid base component comprises refilling said at least one liquid base component via a mixing chamber inlet of said mixing chamber, wherein said mixing chamber includes an overflow.

18. The method of claim 14, wherein adding said at least one additive to said at least one liquid base component comprises adding said at least one additive continuously.

19. The method of claim 14, wherein adding said at least one additive to said at least one liquid base component comprises adding said at least one additive in batches.

20. The method of claim 14, further comprising filling containers with said liquid mixed product directly without storage in an intermediate buffer tank.

21. The method of claim 14, further comprising applying a carbon dioxide gas cushion to said liquid mixed product, said cushion having a pressure lower than a carbon dioxide saturation pressure in said liquid mixed product.

22. An apparatus for producing a mixed beverage having at least one liquid base component and at least one additive, said apparatus comprising: a mixing chamber, a mixing chamber inlet for introducing said at least one liquid base component into said mixing chamber, a metered inlet for metered introduction of said at least one additive into said mixing chamber, an outlet for removing said mixed beverage from said mixing chamber, a dosing facility configured to control metered addition of said at least one additive into said mixing chamber based on a quantity of mixed beverage removed from said mixing chamber via said outlet, and means for at least one of level and volume controlled filling of said at least one base component into said mixing chamber, whereby a volume of said at least one liquid base component and said at least one additive remains unchanged in said mixing chamber.

23. The apparatus of claim 22, wherein said mixed beverage is a carbonated mixed beverage, said apparatus further comprising a common functional container having a first functional space to serve as said mixing chamber and a second functional space for at least one of degassing and carbonation of said at least one liquid base component.

24. The apparatus of claim 22, wherein said mixed beverage is a carbonated beverage, and said apparatus comprises a single functional container for at least one of degassing and carbonation of said at least one liquid base component.

25. The apparatus of claim 24, wherein said single functional container forms a functional space serving as said mixing chamber for at least one of degassing and carbonation of said at least one liquid base component.

26. The apparatus of claim 22, further comprising at least one of a pipe and a pipeline, wherein said mixing chamber is formed from an internal space of said at least one of a pipe and a pipeline.

27. The apparatus of claim 22, wherein said mixing chamber is configured to be at least almost completely filled by said mixture of said at least one liquid base component and said at least one additive.

28. The apparatus of claim 22, further comprising a functional container, said functional container including a horizontal partition level for enabling flow, from top to bottom, of said at least one liquid base component, and from bottom to top for a carbonation medium.

29. The apparatus of claim 22, wherein at least one of said mixing chamber and said mixing chamber inlet comprises an element for determining at least one of fill level and volume in said mixing chamber.

30. The apparatus of claim 22, wherein at least one of said mixing chamber and said mixing chamber inlet includes an element for determining an overflow, and wherein said apparatus further comprises means for causing constant overflow of said element by said at least one liquid base component.
